(19) United States
(12) Patent Application Publication
(10) Pub. No.: US 2025/0165833 A1
(43) Pub. Date: May 22, 2025

(54) Quantum Solver for Binary Black-box Optimization

(71) Applicant: International Business Machines Corporation, Armonk, NY (US)

(72) Inventors: Mitsuharu TAKEORI, Kashiwa-City (JP); Takahiro YAMAMOTO, Bunkyo-ku (JP); Stefan WOERNER, Zürich (CH)

(21) Appl. No.: 18/512,245

(22) Filed: Nov. 17, 2023

(51) Int. Cl. G06N 10/60

(52) U.S. Cl. CPC G06N 10/60

(57) ABSTRACT

Systems and techniques that facilitate quantum black box optimization are provided. For example, one or more embodiments described herein can comprise a system, which can comprise a memory that can store computer executable components. The system can also comprise a processor, operably coupled to the memory that can execute the computer executable components stored in memory. The computer executable components can comprise an approximation component that approximates a minimum value of a function based on a monotonic transformation and determines a monotonic transformation of the function; an initialization component that initializes parameters in a quantum computer for the function; a measurement component that measures bitstrings of a quantum state of the function and estimates amplitudes of the function based on the measured bitstrings; and an optimization component that updates the parameters based on the estimated amplitude and the monotonic transformation.

### BACKGROUND

The subject disclosure relates to black-box optimization, and more specifically to a quantum solver for binary black-box optimization with monotonic transformation of objective functions.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, devices and/or method that facilitate a quantum solver for binary black-box optimization.

According to an embodiment, a system can comprise a processor that executes computer executable components stored in memory. The computer executable components can comprise an approximation component that approximates a minimum value of a function based on a monotonic transformation and determines a monotonic transformation of the function; an initialization component that initializes parameters in a quantum computer for the function; a measurement component that measures bitstrings of a quantum state of the function and estimates amplitudes of the function based on the measured bitstrings; and an optimization component that updates the parameters based on the estimated amplitude and the monotonic transformation. An advantage of such a system is that it can alternate between classically performed steps and steps performed in a quantum computer, thereby decreasing the workload of the quantum system.

According to another embodiment, a computer-implemented method can comprise determining, by a system operatively coupled to a processor, approximating, a minimum value of a function; determining, by the system, a monotonic transformation of the function; initializing, by the system, parameters in a quantum computer for the function; measuring, by the system, bitstrings of a quantum state of the function; estimating, by the system, amplitude of the function based on the measured bitstrings; and updating, by the system, the parameters based on the estimated amplitude and the monotonic transformation. An advantage of such a method is that it can alternate between classically performed steps and steps performed in a quantum computer, thereby decreasing the workload of the quantum system.

According to another embodiment, a computer program product comprising a computer readable storage medium having program instructions embodied therewith, the program instructions executable by a processor to cause the processor to approximate, by the processor, a minimum value of a function; determine, by the processor, a monotonic transformation of the function; initialize, by the processor, parameters in a quantum computer for the function; measure, by the processor, bitstrings of a quantum state of the function; estimate, by the processor, amplitude of the function based on the measured bitstrings; and update, by the processor, the parameters based on the estimated amplitude and the monotonic transformation. An advantage of such a computer program product is that it can alternate between classically performed steps and steps performed in a quantum computer, thereby decreasing the workload of the quantum system.

### DESCRIPTION OF THE DRAWINGS

FIGS. 1 and 2 illustrates block diagram of an example, non-limiting system that can facilitate quantum black-box optimization in accordance with one or more embodiments described herein.

FIG. 3 illustrates an algorithm for a quantum black-box solver in accordance with one or more embodiments described herein.

FIG. 4 illustrates an alternative formulation of an update rule utilized to update parameters in accordance with one or more embodiments described herein.

FIGS. 5 and 6 illustrate graphs comparing the black-box solver as described herein with alternative minimization methods and/or system in accordance with one or more embodiments described herein.

FIGS. 7 and 8 illustrate flow diagrams of example, non-limiting, computer-implemented methods that can facilitate quantum solving of black-box function in accordance with one or more embodiments described herein.

FIG. 9 illustrates a block diagram of an example, non-limiting system that can complete execution of a quantum job in accordance with one or more embodiments described herein.

FIG. 10 illustrates an example, non-limiting environment for the execution of at least some of the computer code in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

Quantum computing is generally the use of quantum-mechanical phenomena for the purpose of performing computing and information processing functions. Quantum computing can be viewed in contrast to classical computing, which generally operates on binary values with transistors. That is, while classical computers can operate on bit values that are either 0 or 1, quantum computers operate on quantum bits (qubits) that comprise superpositions of both 0 and 1, can entangle multiple quantum bits, and use interference.

Within computing, black-box functions are those functions which are not directly accessible and are only viewed based on inputs received and outputs generated. Accordingly, a black box objective function, denoted as ƒ, does not necessarily specify its internal structure. ƒ simply requires inputs to be binary values and the outputs to be real values:

ƒ:x∈ [symbol] ^{N} [symbol] ƒ(x)∈ [symbol] .

In the context of practical optimization problems, ƒ is typically designed as a quadratic or higher-order unconstrained binary optimization (QUBO/HUBO), expressed as:

$${min}_{x ∈ {𝔹}^{N}} {\sum }_{{i}_{1}} {c}_{{i}_{1}} {x}_{{i}_{1}} + {\sum }_{{i}_{1} , {i}_{2}} {c}_{{i}_{1} , {i}_{2}} {x}_{{i}_{1}} {x}_{{i}_{1}} + … + {\sum }_{{i}_{1} , ... {i}_{k}} {c}_{{i}_{1} , ... {i}_{k}} {x}_{{i}_{1}} … {x}_{{i}_{k}}$$

The goal is then to efficiently find solutions to more general optimization problems with the highest possible accuracy within a polynomial time frame. The challenge lies in exploring a practical solver based on classical-quantum hybrid quantum algorithms capable of efficiently solving the given black-box problem, even when employing noisy intermediate-scale quantum devices.

In one or more embodiments, the present disclosure can be implemented in the form of systems, computer-implemented methods, and/or computer program products that can address the above identified issues by approximating a minimum value of a function based on a monotonic transformation, initializing parameters in a quantum computer for the function, measuring bitstrings of a quantum state of the function, estimating amplitude of the function based on the measured bitstrings, and updating the parameters based on the estimated amplitude and the monotonic transformation. Furthermore, the above-described systems, computer-implemented methods, and/or computer program products can involve iteratively alternating between classical and quantum computations. This method offers several advantages, including the ability to utilize relatively shallow quantum circuits, enabling performance by noisy intermediate-scale quantum devices.

For example, the system can generate an approximation of a minimum eigenvalue of the function. This approximation can then be substituted for the actual minimum during further steps in order to properly updated the parameters. Further, the system can generate a monotonic transformation of the function. This monotonic transformation allows the parameterized quantum state generated by the parameters to effectively approximate the eigenstate corresponding to the actual minimum eigenvalue. The system can then initialize the parameters to a base initial value. These parameters are then fed into a parameterized quantum circuit comprising two types of gates; unitary gates and rotational gates. The amplitudes of the parameterized quantum circuit using the current parameters can then be estimated by the quantum system. The estimated amplitudes and the monotonic transformation can then be used to classically calculate expectation values. As these expectation values can be calculated classically, the depth of the circuits within the quantum computer is reduced, thereby enabling the user of cheap quantum computers. The calculated expectation values can then be used to iteratively update all parameters. If convergence criteria is met (e.g., such as a set number update iterations or repetitions) then the updating process can end. Otherwise, additional cycles of updating the parameters can be performed.

As referenced herein, an “entity” can comprise a human, a client, a user, a computing device, a software application, an agent, a machine learning (ML) model, an artificial intelligence (AI) model, and/or another entity.

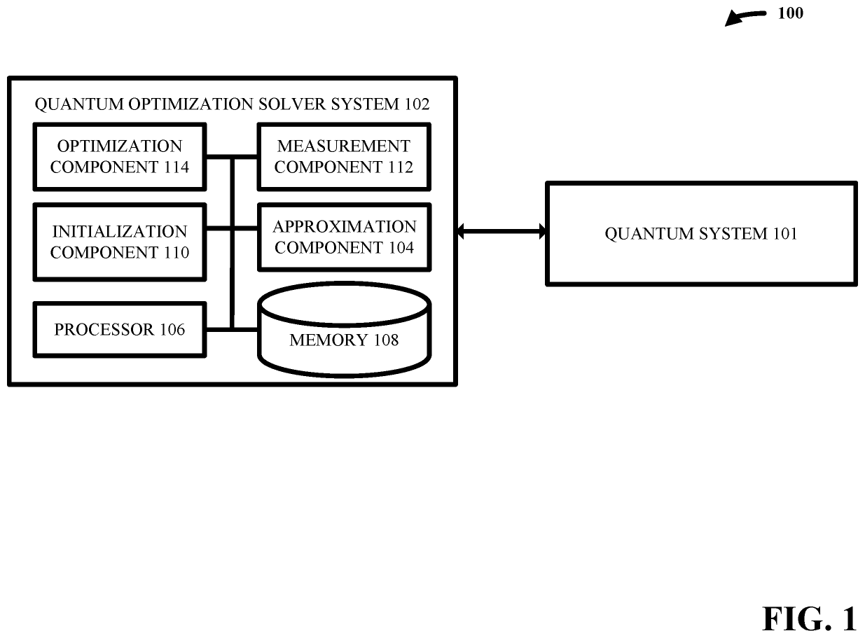

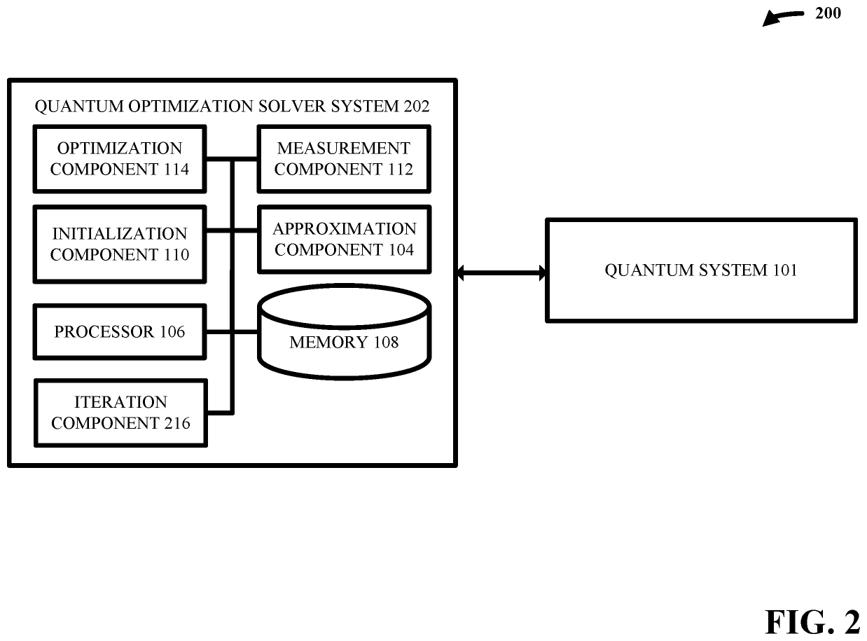

FIGS. 1 and 2 illustrates block diagram of example, non-limiting systems 102 and 202 that can facilitate black-box optimization in accordance with one or more embodiments described herein. Aspects of systems (e.g., system 102 and the like), apparatuses or processes in various embodiments of the present invention can constitute one or more machine-executable components embodied within one or more machines (e.g., embodied in one or more computer readable mediums (or media) associated with one or more machines). Such components, when executed by the one or more machines, e.g., computers, computing devices, virtual machines, etc. can cause the machines to perform the operations described. System 102 can comprise initialization component 110, approximation component 104, measurement component 112, optimization component 114 processor 106, memory 108 and quantum system 101. System 202 can further comprise iteration component 216.

In various embodiments, quantum optimization solver systems 102 and 202 can comprise a processor 106 (e.g., a computer processing unit, microprocessor) and a computer-readable memory 108 that is operably connected to the processor 106. The memory 108 can store computer-executable instructions which, upon execution by the processor, can cause the processor 106 and/or other components of the quantum optimization solver systems 102 and 202 (e.g., initialization component 110, approximation component 104, measurement component 112, optimization component 114, iteration component 216, processor 106, memory 108 and/or quantum system 101) to perform one or more acts. In various embodiments, the memory 108 can store computer-executable components (e.g., initialization component 110, approximation component 104, measurement component 112, optimization component 114, iteration component 216 processor 106, memory 108 and/or quantum system 101), the processor 106 can execute the computer-executable components.

In one or more embodiments, approximation component 104 can approximate a minimum value of a function ƒ and determine a monotonic transformation to apply to the function. In an embodiment, a linear operator H that acts on a Hilbert space of dimension M=2^{N} can be defined as

$$H ( {\sum }_{k} {a}_{k} \vert {b}_{k} 〉 ) = {\sum }_{k} {a}_{k} f ( {b}_{k} ) \vert {b}_{k} 〉$$

where bₖ represents a binary string of length N generated from the decimal number k. The target problem

$${min}_{x ∈ {𝔹}^{N}} f ( x ) \qquad ( 1 )$$

can be equivalently stated as finding the eigenstate corresponding to the minimum eigenvalue λ₀ of H.

A parameterized quantum state denoted as |ψ(θ₀) [symbol] =U(θ)|0 [symbol] can serve as an approximation to a solution. Here θ={θⱼ}ⱼ₌₀^{K-1} is a set of K parameters, which can be controlled classically. Accordingly, the number of parameters K is polynomial in the size of the target problem. Therefore, the overall goal is to optimize the parameterized state |ψ(θ₀) [symbol] by adjusting values of θ to minimize the value of L defined as

$${L ( θ ) = \frac{1}{2} ‖ \vert ψ ( {θ}_{0} ) 〉 - \frac{G ( H - {λ}_{0} I ) \vert ψ ( {θ}_{0} ) 〉}{‖ G ( H - {λ}_{0} I ) \vert ψ ( {θ}_{0} ) 〉 ‖} ‖}^{2} \qquad ( 2 )$$

Here G is a negative monotonic transformation of H. Specifically, G maps the spectral set SP(H) of H into [0, ∞) reserving the order of SP(H). When G is designed in such a way that the difference between the spectral projection P_{λ}_{₀}, associated with λ₀ is minimized, then the parameterized quantum state will effectively approximate the eigenstate corresponding to the minimum eigenvalue λ₀. When constructing G, the function should decrease in a consistent manner such that λ₀< . . . <λ_{M-1} [symbol] G(λ₀)> . . . >G(λ_{M-1})≥0. To improve accuracy, the function should align with the spectral projection P_{λ}_{₀} onto the eigenspace related to the smallest eigenvalue, making the right-hand side of the following inequality relatively small: ∥P_{λ}_{₀}−G(H−λ₀I)∥≤G(Δ₀), where λ₀=inf_{j>0}|λ₀−λⱼ| represents the spectral gap. In practical terms, an exponential can be used. Accordingly, G can be defined as G(x)=e^{-tH} for some fixed t>0. In some embodiments, a value of t can be selected by testing different values of t and evaluating equation (3) in order to select a value that has low variance and remains numerically stable within a feasible range. In some embodiments, the largest possible value of t that satisfies these criteria can be chosen. To ensure stable calculations, an approximation of the minimum eigenvalue, denoted as [symbol] can be approximated using the following formulation:

$$= - \frac{1}{s} log ( 〈 {ψ}_{uni} \vert {e}^{- sH} \vert {ψ}_{uni} 〉 ) \qquad ( 3 )$$

The state ψᵤₙᵢ denotes a superposition state where all basis states have equal amplitudes, ψᵤₙᵢ=|+ [symbol] ^{⊗N}=[1, . . . ,1]/2^{N}. As s approaches infinity, the estimated minimum eigenvalue [symbol] converges to the actual minimum eigenvalue λ₀. This approximated minimum eigenvalue can be utilized as a substitute for the true minimum during the calculation of expectation values as part of a parameter update process. Furthermore, this allows for classical sampling methods such as Monte Carlo methods to estimate the expectation value, thereby reducing the workload of associated quantum computers.

In one or more embodiments, initialization component 110 can initialize parameters in a quantum computer (e.g., quantum system 101) for the target function. The parameterized quantum circuit |ψ(θ₀) [symbol] can comprise two types of gates. The first type of gate comprises fixed unitary gates like the control-Z and the control-X gate. The second type of gate comprise rotational gates denotes as

$${R}_{j} ( {θ}_{j} ) = {e}^{- i \frac{1}{2} {θ}_{j} {A}_{j}} ,$$

where Aⱼ satisfies the condition Aⱼ²=I. These rotational gates can involve the utilization of Pauli matrices such as Z-rotation and X-rotation. Accordingly, initialization component 110 can set the parameter set θ to an initial value of θ₀, wherein θ₀ can be set in a way that satisfies |ψ(θ₀) [symbol] =|+)^{⊗N}(*).

In one or more embodiments, measurement component 112 can sample bitstrings from the quantum state produced by the parameterized quantum circuit initialized by initialization component 110. Once the bitstrings are measured, measurement component 112 can estimate the amplitude of |ψ(θ₀) [symbol] . In some embodiments, the amplitude can be estimated by using a classical Monte Carlo approach to sample the bitstrings.

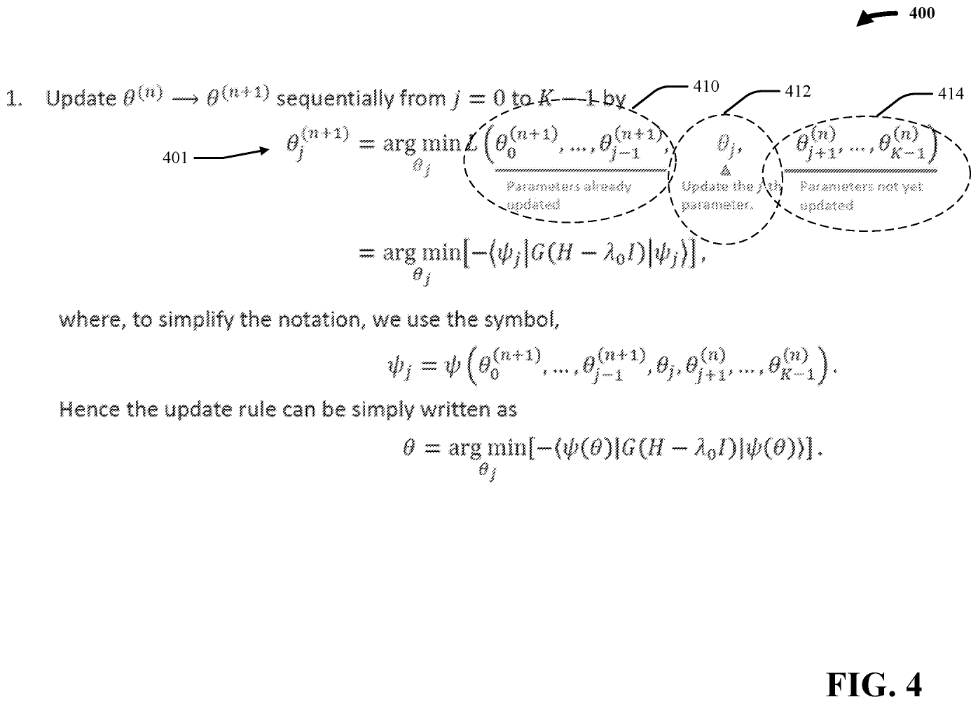

In one or more embodiments, optimization component 114 can update the parameters of the quantum circuit based on the estimate amplitude. In an embodiment, the estimated amplitudes from measurement component 112 can be utilized by optimization component 114 in order to evaluate expectation values of the function, which can then be used in a Gauss-seidel-type alternating direction method (as shown in FIG. 4) to update the parameters, θ. For example, consider the expectation value z(θ)=− [symbol] ψ(θ)|G(H−λ₀I)|ψ(θ) [symbol] . Since H is diagonal, z can be expressed as z(θ)=Σₖ G(ƒ(bₖ)−λ₀)| [symbol] bₖ|ψ(θ) [symbol] |². Due to the use of the monotonic transformation, the expectation values can be calculated classically, thereby reducing the computing requirements of the quantum computer. Using the above formulation, optimization component 114 can evaluate z₀ and z_{+π/2} of G (H−λ₀I) classically. These expectation values can then be used to update the parameters θ. In an embodiment, z can be derived as a scholar function in terms of the j-th variable θⱼ, z(θ)=a₁ cos(θⱼ−a₂)+a₃. Introducing the orthonormal basis e={eⱼ}ⱼ₌₀^{K-1} of [symbol] ^{K}, allows for z_{δ}=z(θ+δeⱼ). Therefore,

$${Δθ}_{j} = {tan}^{- 1} ( \frac{{z}_{π / r} - {z}_{- π / 2}}{2 {z}_{0} - ( {z}_{π / 2} + {z}_{- π / 2} )} ) + \{ \begin{matrix}π & if 2 {z}_{0} > {z}_{π / 2} + {z}_{- π / 2} \\ 0 & if 2 {z}_{0} \leq {z}_{π / 2} + {z}_{- π / 2}\end{matrix}$$

Based on this, one arrives at arg min z(θ)=θⱼ+Δθⱼ, which provides an explicit expression for the update rule: θⱼ⁽ⁿ⁺¹⁾=θⱼ⁽ⁿ⁾+Δθⱼ. Optimization component 114 can then use this rule to update θ for each component j of θ.

Turning to FIG. 2, in one or more embodiments, iteration component 216 can determine how many iterations optimization should take place in order to solve the objective function. For example, after optimization component updates the parameter θ, iteration component 216 can determine whether to end the optimization process or to signal optimization component 114 to perform another cycle of updates to parameter θ based on a performance criteria. In an embodiment, the performance criteria can comprise a defined number of update iterations. For example, if the number of update iterations has been met, iteration component 216 can signal optimization component 114 to end updating the parameter θ. Otherwise, iteration component 216 can signal optimization component 114 to perform another cycle of updates to parameter θ. In an embodiment, the performance criteria can comprise an accuracy metric. For example, the amplitude or expectation value of the parameterized circuit can be compared to an intended accuracy level. If the parametrized circuit with the current parameters θ meets or exceeds the intended accuracy, then the updating can stop. Otherwise, iteration component 216 can signal optimization component 114 to perform additional updates.

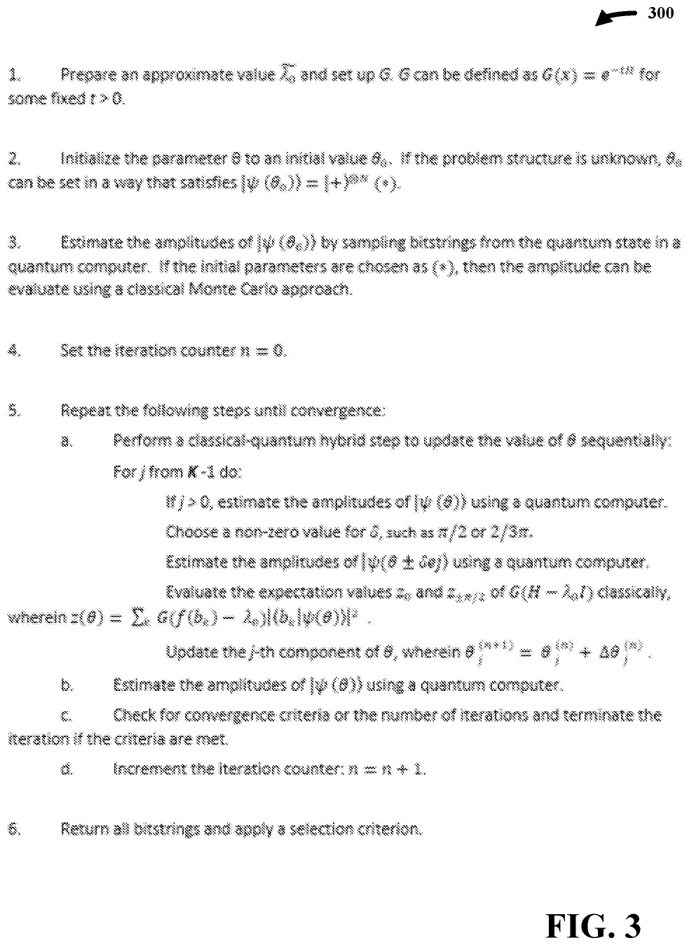

FIG. 3 illustrates an algorithm for a quantum black-box solver in accordance with one or more embodiments described herein.

At step 1, an approximation of a minimum eigenvalue, [symbol] , and a monotonic transformation G can be determined by approximation component 104 as described above in reference to FIG. 1. The approximation of the minimum eigenvalue, [symbol] , and the monotonic transformation G can be utilized to minimize the value of L as defined in the problem statement;

$${L ( θ ) = \frac{1}{2} ‖ \vert ψ ( {θ}_{0} ) 〉 - \frac{G ( H - {λ}_{0} I ) \vert ψ ( {θ}_{0} ) 〉}{‖ G ( H - {λ}_{0} I ) \vert ψ ( {θ}_{0} ) 〉 ‖} ‖}^{2}$$

as described in greater detail above in relation to FIG. 1. At step 2, initialization component 110 can initialize a parameterized quantum circuit in a quantum computer by setting the parameters, θ, of the circuit to an initial value θ₀. As described above, the parameters θ will be updates to optimize the quantum state |ψ(θ₀) [symbol] to minimize the value of L. At step 3, measurement component 112 can measure bitstrings from the quantum state produced by the circuit parameters. These measured bitstrings can then be used to estimate the amplitudes of the quantum state |ψ(θ₀) [symbol] classically using a Monte Carlo. At step 4, an iteration counter can be set to 0. At step 5, an update loop can begin in order to optimize the parameters θ to produce a minimized value L. At step 5a, a classical-quantum hybrid computation can be performed to sequentially update the parameters θ. As described above in reference to FIG. 1, parameters θ will have K number of parameters. Therefore, for each parameter j of parameters θ, measurement component 112 can estimate the amplitudes of the quantum states |ψ(θ₀) [symbol] and |ψ(θ±δej [symbol] using a quantum computer (e.g., quantum system 101), wherein δ is a non-zero value, such as πt/2 or 2/3π. Using these amplitudes, the approximate minimum eigenvalue [symbol] and the monotonic transformation G, optimization component 114 can classically evaluate the expectation values z₀ and z_{+π/2} of G(H−λ₀I), wherein z(θ)=Σₖ G(ƒ(bₖ)−λ₀)| [symbol] bₖ|ψ(θ) [symbol] |². Based on these expectation values, optimization component 114 can update the j-th parameter of θ based on the update rule of θⱼ⁽ⁿ⁺¹⁾=θⱼ⁽ⁿ⁾+Δθⱼ⁽ⁿ⁾. At 5b, the measurement component can estimate the amplitudes of |ψ(θ) [symbol] again in order to compare to the amplitude previously estimated at step 3. At step 5c, iteration component 216 can check the convergence criteria (e.g., the number of iterations performed and/or a comparison of the amplitudes) to determine whether to continue updating the parameters. If the convergence criteria are met, then at step 6 the bitstrings produced by the quantum circuit with the updated parameters can be output to an entity. If the convergence criteria are not met, then step 5a-5d can be repeated until the convergence criteria are met.

FIG. 4 illustrates an alternative formulation of an update rule 400 utilized to update parameters in accordance with one or more embodiments described herein.

As shown, the optimization component 114 can update parameters θⱼ⁽ⁿ⁾→θⱼ⁽ⁿ⁺¹⁾ sequentially starting with the j-th parameter for all K parameters of set θ. As illustrated in equation 401, the update rule can be broken down into parameters that have been already updated 410, the parameters currently being updated 412, and future parameters to be updated 414. Furthermore, this leads to the simplification of θ=arg min[− [symbol] ψ(θ)|G(H−λ₀I)|ψ(θ) [symbol] ].

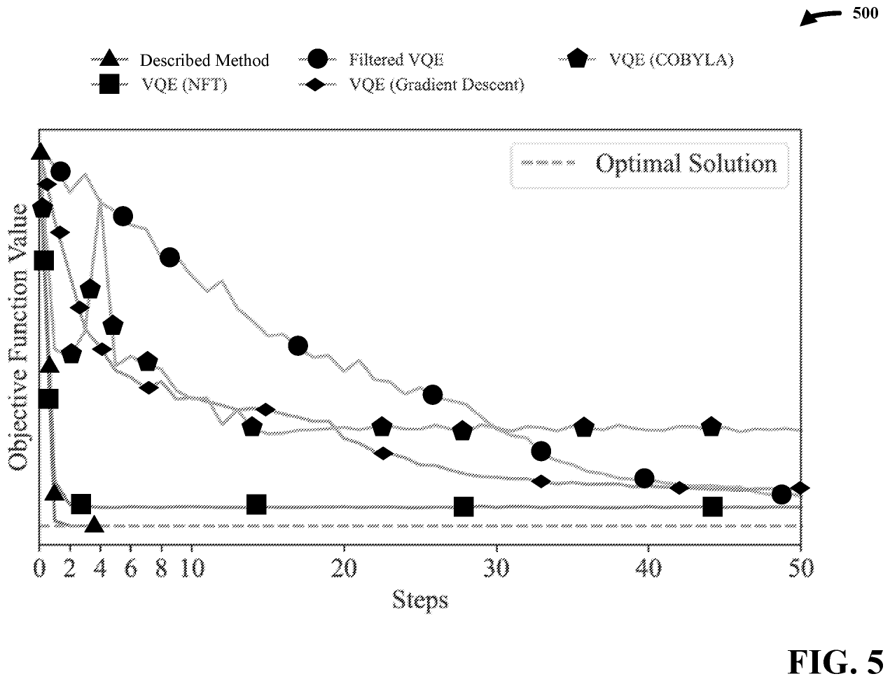

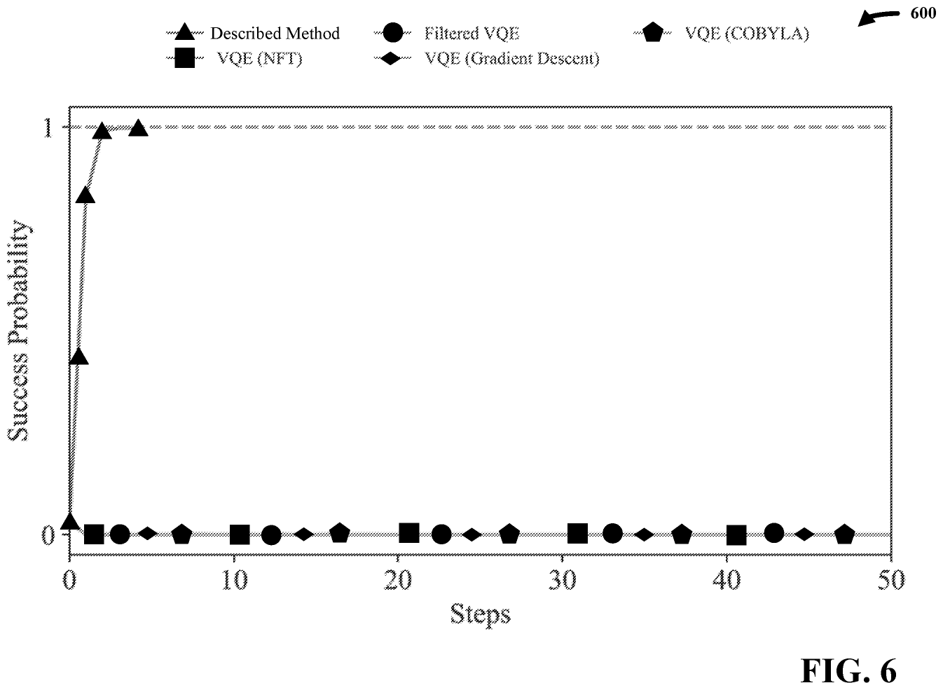

FIGS. 5 and 6 illustrate graphs comparing the black-box solver as described herein with alternative minimization methods and/or system in accordance with one or more embodiments described herein. As shown, the y-axis of graph 500 shows the value of the objective function that is minimized, and the x-axis shows the number of steps or iterations of minimization performed. As illustrated, the method described herein achieves the same value as the optimal solution in two iterations, while none of the other methods shown achieve comparable results with far more iterations. For graph 600, the y-axis shows the probability of success of determining the minimum of the objective function, and the x-axis shows the number of steps or iterations of minimization performed. As illustrated, the method described herein achieves a success probability of 1 in less than 10 iterations, while none of the other methods shown achieve a similar success probability.

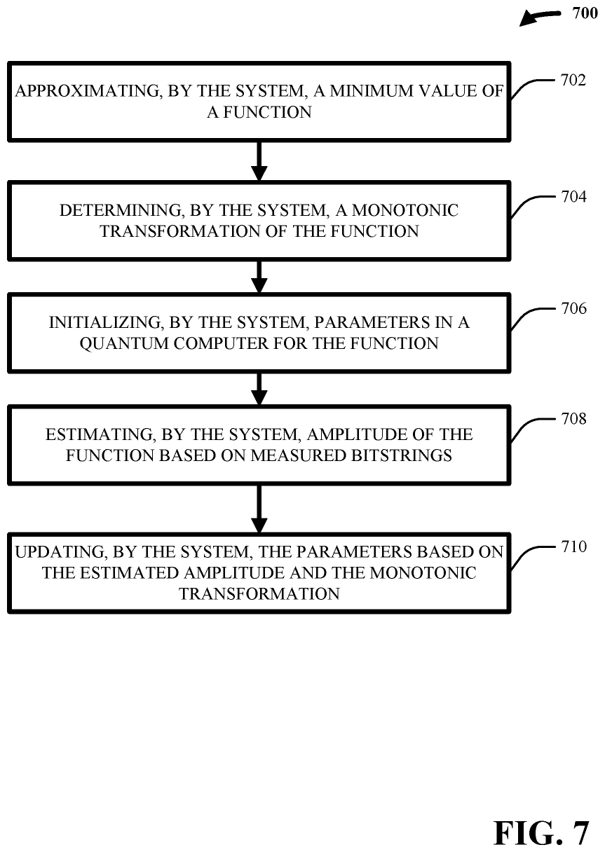

FIG. 7 illustrates a flow diagram of an example, non-limiting, computer-implemented method 700 that can facilitate quantum solving of black-box function in accordance with one or more embodiments described herein.

At 702, method 700 can comprise approximating, by a system (e.g., system 100/200 and/or approximation component 104) a minimum value of a function. For example, as described above in reference to FIGS. 1-3, approximation component 104 can generate an approximation [symbol] of an absolute minimum eigenvalue λ₀ of the function.

At 704, method 700 can comprise determining, by the system (e.g., system 100/200 and/or approximation component 104) a monotonic transformation of the function. For example, as described above in reference to FIGS. 1-3, approximation component 104 can determine a monotonic transformation that can be applied to the function as part of an update process.

At 706, method 700 can comprise initializing, by the system (e.g., system 100/200 and/or initialization component 110) parameters in a quantum computer for the function. For example, as described above in reference to FIGS. 1-3, the parameter set of a parameterized circuit θ, can be initialized as θ₀, wherein θ₀ satisfies |ψ(ω₀) [symbol] =|+ [symbol] ^{⊗N} (*).

At 708, method 700 can comprise estimating, by the system (e.g., system 100/200 and/or initialization component 110) amplitudes of the function based on measured bitstrings. For example, the bitstrings produced by the parameterized circuit with the parameters θ can be measured or sampled using a Monte Carlo sampling technique.

At 710, method 700 can comprise updating, by the system (e.g., system 100/200 and/or optimization component 114), the parameters based on the estimated amplitudes and the monotonic transformation. For example, as described above in relation to FIGS. 1-3, the estimated amplitudes and the monotonic transformation can be utilized to calculate expectation values classically. These expectation values can then be utilized to update each parameter within the parameter set θ, in order to minimize L of equation 2.

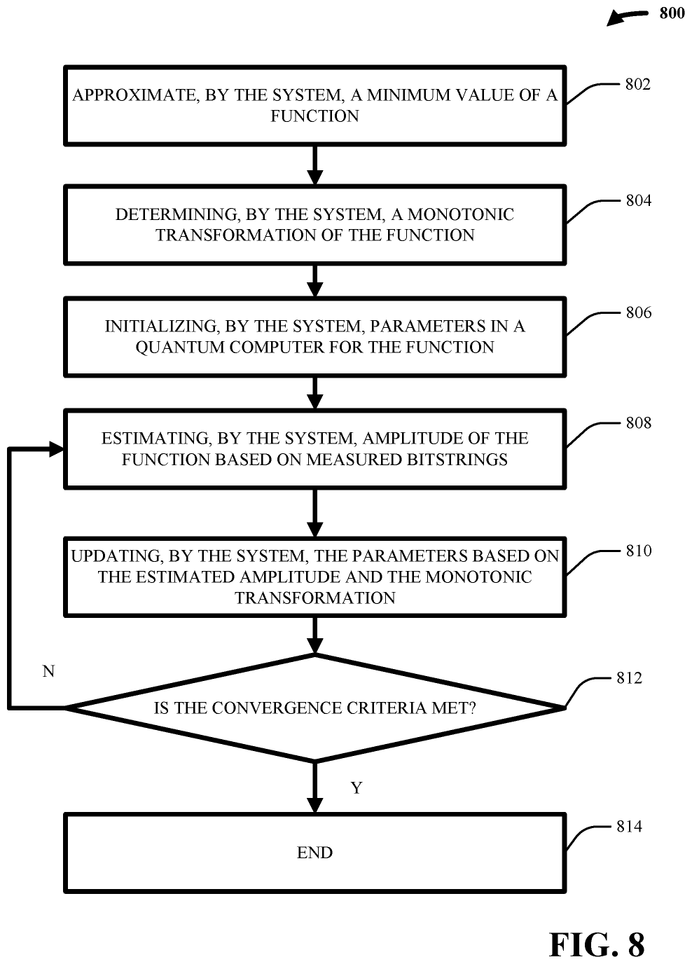

FIG. 8 illustrates a flow diagram of an example, non-limiting, computer-implemented method 800 that can facilitate quantum solving of black-box function in accordance with one or more embodiments described herein.

At 802, method 800 can comprise approximating, by a system (e.g., system 100/200 and/or approximation component 104) a minimum value of a function. For example, as described above in reference to FIGS. 1-3, approximation component 104 can generate an approximation [symbol] of an absolute minimum eigenvalue λ₀ of the function.

At 804, method 800 can comprise determining, by the system (e.g., system 100/200 and/or approximation component 104) a monotonic transformation of the function. For example, as described above in reference to FIGS. 1-3, approximation component 104 can determine a monotonic transformation that can be applied to the function as part of an update process.

At 806, method 800 can comprise initializing, by the system (e.g., system 100/200 and/or initialization component 110) parameters in a quantum computer for the function. For example, as described above in reference to FIGS. 1-3, the parameter set of a parameterized circuit θ, can be initialized as θ₀, wherein θ₀ satisfies |ψ(θ₀) [symbol] =|+ [symbol] ^{⊗N} (*).

At 808, method 800 can comprise estimating, by the system (e.g., system 100/200 and/or initialization component 110) amplitudes of the function based on measured bitstrings. For example, the bitstrings produced by the parameterized circuit with the parameters θ can be measured or sampled using a Monte Carlo sampling technique.

At 810, method 800 can comprise updating, by the system (e.g., system 100/200 and/or optimization component 114), the parameters based on the estimated amplitudes and the monotonic transformation. For example, as described above in relation to FIGS. 1-3, the estimated amplitudes and the monotonic transformation can be utilized to calculate expectation values classically. These expectation values can then be utilized to update each parameter within the parameter set θ, in order to minimize L of equation 2.

At 812, method 800 can comprise determining, by the system (e.g., system 100/200 and/or iteration component 216), whether convergence criteria has been met by the updated parameters. For example, as described above in reference to FIGS. 1-3, iteration component 216 can determine whether a set number of update iterations have passed and/or whether the updated parameters produce an output that is within a defined accuracy measurement. In response to a “YES” determination, updating of the parameters can end at step 814. In response to a “NO” determination, method 800 can return to step 808 and repeat updating of the parameters.

A practical application of quantum optimization solver system 102 is that is allows for the calculation of expectation values classically, rather than within a quantum system. This decreased the quantum circuit depth required to optimize the parameters, thus allowing for execution with reduced quantum hardware requirements.

It is to be appreciated that quantum optimization solver system 102 can utilize various combination of electrical components, mechanical components, and circuitry that cannot be replicated in the mind of a human or performed by a human as the various operations that can be executed by quantum optimization solver system 102 and/or components thereof as described herein are operations that are greater than the capability of a human mind. For instance, the amount of data processed, the speed of processing such data, or the types of data processed by quantum optimization solver system 102 over a certain period of time can be greater, faster, or different than the amount, speed, or data type that can be processed by a human mind over the same period of time. In another example, a human mind is not capable of performing quantum operations. According to several embodiments, quantum optimization solver system 102 can also be fully operational towards performing one or more other functions (e.g., fully powered on, fully executed, and/or another function) while also performing the various operations described herein. It should be appreciated that such simultaneous multi-operational execution is beyond the capability of a human mind. It should be appreciated that quantum optimization solver system 102 can include information that is impossible to obtain manually by an entity, such as a human user. For example, the type, amount, and/or variety of information included in quantum optimization solver system 102, such as quantum states of qubits, can be more complex than information obtained manually by an entity, such as a human user.

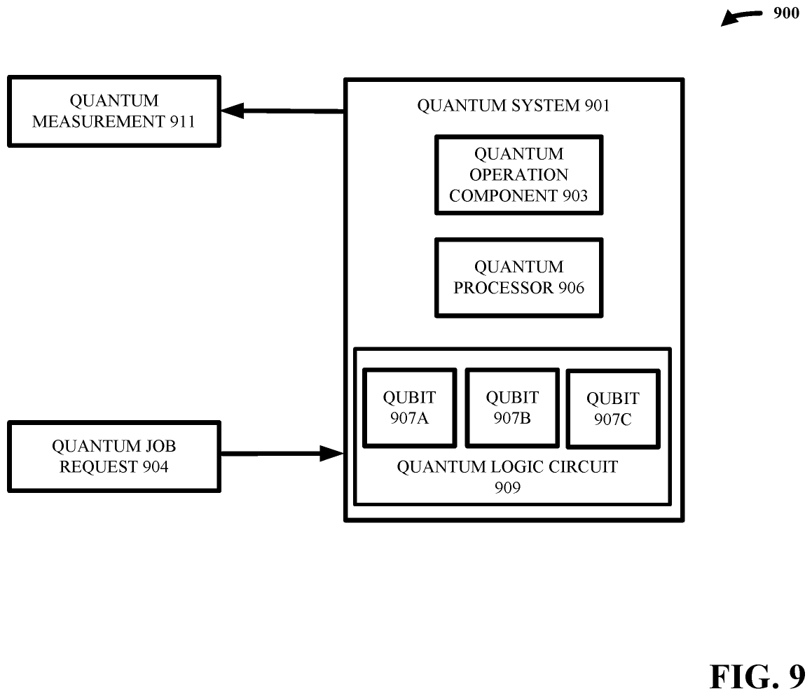

Turning generally to FIG. 9, one or more embodiments described herein can include one or more devices, systems and/or apparatuses that can facilitate executing one or more quantum operations to facilitate output of one or more quantum results. For example, FIG. 9 illustrates a block diagram of an example, non-limiting system 900 that can complete the execution of a quantum job.

The quantum system 901 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuitry can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement 911, can be responsive to the quantum job request 904 and associated input data and can be based at least in part on the input data, quantum functions and/or quantum computations.

In one or more embodiments, the quantum system 901 can comprise one or more quantum components, such as a quantum operation component 903, a quantum processor 906 and a quantum logic circuit 909 comprising one or more qubits (e.g., qubits 907A, 907B and/or 907C), also referred to herein as qubit devices 907A, 907B and 907C. The quantum processor 906 can be any suitable processor, such as being capable of controlling qubit coherence and the like. The quantum processor 906 can generate one or more instructions for controlling the one or more processes of the quantum operation component 903.

The quantum operation component 903 that can obtain (e.g., download, receive, search for and/or the like) a quantum job request 904 requesting execution of one or more quantum programs. The quantum operation component 903 can determine one or more quantum logic circuits, such as the quantum logic circuit 909, for executing the quantum program. The request 904 can be provided in any suitable format, such as a text format, binary format and/or another suitable format. In one or more embodiments, the request 904 can be received by a component other than a component of the quantum system 901, such as a by a component of a classical system coupled to and/or in communication with the quantum system 901.

The quantum operation component 903 can perform one or more quantum processes, calculations and/or measurements for operating one or more quantum circuits on the one or more qubits 907A, 907B and/or 907C. For example, the quantum operation component 903 can operate one or more qubit effectors, such as qubit oscillators, harmonic oscillators, pulse generators and/or the like to cause one or more pulses to stimulate and/or manipulate the state(s) of the one or more qubits 907A, 907B and/or 907C comprised by the quantum system 901. That is, the quantum operation component 903, such as in combination with the quantum processor 906, can execute operation of a quantum logic circuit on one or more qubits of the circuit (e.g., qubit 907A, 907B and/or 907C). The quantum operation component 903 can output one or more quantum job results, such as one or more quantum measurements 999, in response to the quantum job request 904.

It will be appreciated that the following description(s) refer(s) to the operation of a single quantum program from a single quantum job request. However, it also will be appreciated that one or more of the processes described herein can be scalable, such as execution of one or more quantum programs and/or quantum job requests in parallel with one another.

In one or more embodiments, the non-limiting system 900 can be a hybrid system and thus can include both one or more classical systems, such as a quantum program implementation system, and one or more quantum systems, such as the quantum system 901. In one or more other embodiments, the quantum system 901 can be separate from, but function in combination with, a classical system.

In such case, one or more communications between one or more components of the non-limiting system 900 and a classical system can be facilitated by wired and/or wireless means including, but not limited to, employing a cellular network, a wide area network (WAN) (e.g., the Internet), and/or a local area network (LAN). Suitable wired or wireless technologies for facilitating the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an ANT, an ultra-wideband (UWB) standard protocol and/or other proprietary and/or non-proprietary communication protocols.

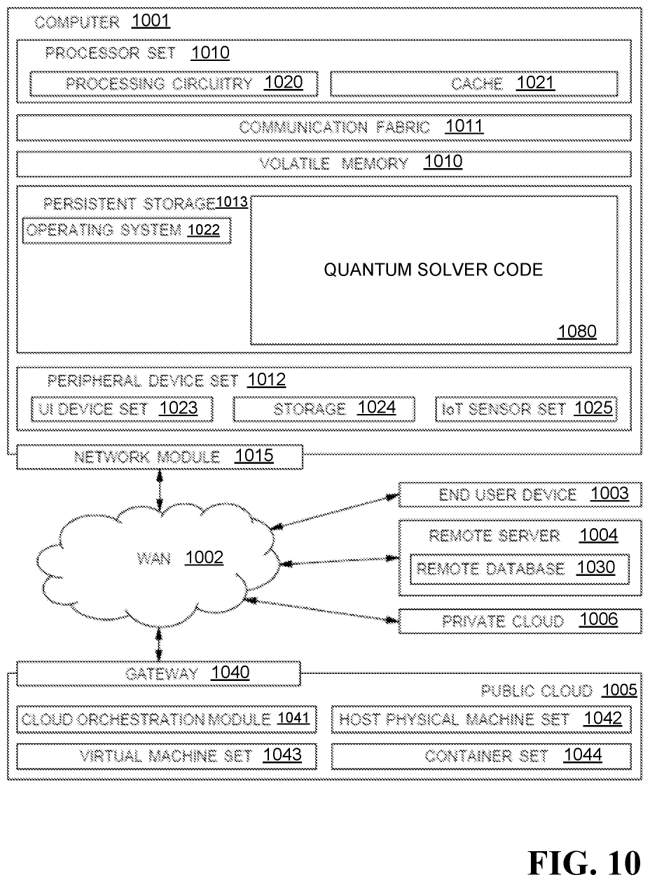

FIG. 10 and the following discussion are intended to provide a brief, general description of a suitable computing environment 1000 in which one or more embodiments described herein at FIGS. 1-8 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as translation of an original source code based on a configuration of a target system by the quantum black box solver code 1080. In addition to block 1080, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1010, persistent storage 1013 (including operating system 1022 and block 1080, as identified above), peripheral device set 1012 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method can be distributed among multiple computers and/or between multiple locations. On the other hand, in this presentation of computing environment 1000, detailed discussion is focused on a single computer, specifically computer 1001, to keep the presentation as simple as possible. Computer 1001 can be located in a cloud, even though it is not shown in a cloud in FIG. 10. On the other hand, computer 1001 is not required to be in a cloud except to any extent as can be affirmatively indicated.

PROCESSOR SET 1010 includes one, or more, computer processors of any type now known or to be developed in the future. Processing circuitry 1020 can be distributed over multiple packages, for example, multiple, coordinated integrated circuit chips. Processing circuitry 1020 can implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set can be located “off chip.” In some computing environments, processor set 1010 can be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods can be stored in block 1080 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1010 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1010 is located in a single package and is internal to computer 1001, but, alternatively or additionally, the volatile memory can be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 can be a read only memory (ROM), but typically at least a portion of the persistent storage allows writing of data, deletion of data and re-writing of data. Some familiar forms of persistent storage include magnetic disks and solid-state storage devices. Operating system 1022 can take several forms, such as various known proprietary operating systems or open-source Portable Operating System Interface type operating systems that employ a kernel. The code included in block 1080 typically includes at least some of the computer code involved in performing the inventive methods.

PERIPHERAL DEVICE SET 1012 includes the set of peripheral devices of computer 1001. Data communication connections between the peripheral devices and the other components of computer 1001 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 can include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 can be persistent and/or volatile. In some embodiments, storage 1024 can take the form of a quantum computing storage device for storing data in the form of qubits. In embodiments where computer 1001 is required to have a large amount of storage (for example, where computer 1001 locally stores and manages a large database) then this storage can be provided by peripheral storage devices designed for storing large amounts of data, such as a storage area network (SAN) that is shared by multiple, geographically distributed computers. IoT sensor set 1025 is made up of sensors that can be used in Internet of Things applications. For example, one sensor can be a thermometer and another sensor can be a motion detector.

NETWORK MODULE 1015 is the collection of computer software, hardware, and firmware that allows computer 1001 to communicate with other computers through WAN 1002. Network module 1015 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001) and can take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 can be a client device, such as thin client, heavy client, mainframe computer and/or desktop computer.

REMOTE SERVER 1004 is any computer system that serves at least some data and/or functionality to computer 1001. Remote server 1004 can be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data can be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs can be stored as images and can be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware and firmware allowing public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer-implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system comprising:
a memory that stores computer executable components;
a processor that executes computer executable components stored in the memory, wherein the computer executable components comprise:
an approximation component that approximates a minimum value of a function based on a monotonic transformation and determines a monotonic transformation of the function;
an initialization component that initializes parameters in a quantum computer for the function;
a measurement component that measures bitstrings of a quantum state of the function and estimates amplitudes of the function based on the measured bitstrings; and
an optimization component that updates the parameters based on the estimated amplitude and the monotonic transformation.

2. The system of claim 1, wherein the parameters comprise a parameterized quantum circuit.

3. The system of claim 2, wherein the parameterized quantum circuit comprises fixed unitary gates and rotational gates.

4. The system of claim 1, wherein the estimating the amplitudes of the function comprises a Monte Carlo approach.

5. The system of claim 1, wherein the computer executable components further comprise:
an iteration component that iteratively updates the parameters until a defined criteria is met.

6. The system of claim 5, wherein the defined criteria comprise a set number of update iterations.

7. The system of claim 5, wherein the defined criteria comprise the estimated amplitude being less than or equal to an intended accuracy value.

8. A computer-implemented method comprising:
approximating, by a system operatively coupled to a processor, a minimum value of a function;
determining, by the system, a monotonic transformation of the function;
initializing, by the system, parameters in a quantum computer for the function;
measuring, by the system, bitstrings of a quantum state of the function;
estimating, by the system, amplitude of the function based on the measured bitstrings; and
updating, by the system, the parameters based on the estimated amplitude and the monotonic transformation.

9. The computer-implemented method of claim 8, wherein the parameters comprise a parameterized quantum circuit.

10. The computer-implemented method of claim 9, wherein the parameterized quantum circuit comprises fixed unitary gates and rotational gates.

11. The computer-implemented method of claim 8, wherein the estimating the amplitude of the function comprises a Monte Carlo approach.

12. The computer-implemented method of claim 8, further comprising iteratively updating, by the system, the parameters until a defined criteria is met.

13. The computer-implemented method of claim 12, wherein the defined criteria comprise a set number of update iterations.

14. The computer-implemented method of claim 12, wherein the defined criteria comprise the estimated amplitude being less than or equal to an intended accuracy value.

15. A computer program product, comprising a computer readable storage medium having program instructions embodied therewith, the program instructions executable by a processor to cause the processor to:
approximate, by the processor, a minimum value of a function;
determine, by the processor, a monotonic transformation of the function;
initialize, by the processor, parameters in a quantum computer for the function;
measure, by the processor, bitstrings of a quantum state of the function;
estimate, by the processor, amplitude of the function based on the measured bitstrings; and
update, by the processor, the parameters based on the estimated amplitude and the monotonic transformation.

16. The computer program product of claim 15, wherein the parameters comprise a parameterized quantum circuit.

17. The computer program product of claim 16, wherein the parameterized quantum circuit comprises fixed unitary gates and rotational gates.

18. The computer program product of claim 15, wherein the program instructions are further executable by the processor to cause the processor to:
iteratively update, by the processor, the parameters until a defined criteria is met.

19. The computer program product of claim 18, wherein the defined criteria comprise a set number of update iterations.

20. The computer program product of claim 18, wherein the defined criteria comprise the estimated amplitude being less than or equal to an intended accuracy value.
